(19) United States
(12) Patent Application Publication
(10) Pub. No.: US 2005/0088382 A1
(43) Pub. Date: Apr. 28, 2005

(54) Surface light source

(76) Inventors: Hyeon-Yong Jang, Osan-si (KR); Hyoung-Joo Kim, Uiwang-si (KR); Geun-Young Kim, Seoul (KR); Sang-Yu Lee, Yongin-si (KR)

Correspondence Address: CANTOR COLBURN, LLP, 55 GRIFFIN ROAD SOUTH, BLOOMFIELD, CT, 06002, US

(21) Appl. No.: 10/934,144

(22) Filed: Sep. 3, 2004

(30) Foreign Application Priority Data
Sep. 3, 2003 (KR) 2003-61396

(51) Int. Cl. G09G 3/34; G02B 27/10

(52) U.S. Cl. 345/84

(57) ABSTRACT

A surface light source has a body including a first substrate, a second substrate facing with the first substrate, and a space-dividing member. The first substrate has first fluorescent patterns to convert an invisible ray into a visible ray. The first fluorescent patterns are formed in parallel by a first interval. The space-dividing member is interposed between the first and second substrates to form a discharge space. The space-dividing member has a width less than the first interval to emit the visible ray between the space-dividing member and the first fluorescent patterns. A power supply member generates the invisible ray in the discharge space. Thus, the surface light source enhances brightness of the visible ray emitted from the body.

### CROSS-REFERENCE OF RELATED APPLICATIONS

The present application claims priority from Korean Patent Application No. 2003-61396, filed on Sep. 3, 2003, the disclosure of which is hereby incorporated herein by reference in its entirety.

### BACKGROUND OF THE INVENTION

1. Field of the Invention

The present invention relates to a surface light source, a method of manufacturing the surface light source, and a liquid crystal display (LCD) device having the surface light source. More particularly, the present invention relates to a surface light source having an enhanced brightness to improve an image display quality, a method of manufacturing the surface light source, and an LCD device having the surface light source.

2. Description of the Related Art

In general, a liquid crystal has an electrical characteristic and an optical characteristic. An arrangement of the liquid crystal is varied in accordance with a direction of an electric field, thereby changing light transmittance of the liquid crystal.

A liquid crystal display device (LCD) displays an image by using the electrical and the optical characteristics of the liquid crystal. The LCD device has merits of a lightweight and a small size compared to a cathode ray tube type display device so that the liquid crystal display device is widely used in a portable computer, a communication device, an electronic appliance, liquid crystal television receiver and the space industry.

To display the image, the liquid crystal display device may include a liquid crystal control member for controlling the liquid crystal molecules and a light-providing member for providing the liquid crystal with a light.

The liquid crystal control member includes a pixel electrode, a common electrode and the liquid crystal. The pixel electrode is disposed on a first substrate in a matrix shape. The common electrode is disposed on a second substrate that is opposite to the pixel electrode of the first substrate. A liquid crystal layer having the liquid crystal molecule is interposed between the pixel electrode and the common electrode. A thin film transistor (TFT) for supplying a pixel voltage to the pixel electrode is connected to the pixel electrode. A reference voltage is supplied to the common electrode. The pixel electrode and the common electrode of the LCD device having the light-providing member include a transparent conductive material.

The light-providing member provides the liquid crystal of the liquid crystal control member with the light. The light sequentially passes through the pixel electrode, the liquid crystal and the common electrode. A display quality of the image has an influence in accordance with a brightness and uniformity of the brightness. Generally, the display quality of the image is proportional to the brightness and the uniformity of the brightness.

A general light-providing member of the LCD device is usually used in a cold cathode fluorescent lamp (CCFL), or a light emitting diode (LED). The CCFL has a high brightness, a long lifetime, a white light generated using sunlight and a less heat generated compared to an incandescent lamp. The LED has a low power consumption and a high brightness.

However, a general CCFL or the LED has a poor uniformity of the brightness.

To improve the brightness uniformity, the light-providing member for generating the light using the CCFL, or the LED includes an optical member such as a light guide plate, a diffusion member and a prism sheet.

The LCD device using the CCFL, or the LED may be large in volume and heavy weight due to the optical member.

### SUMMARY OF THE INVENTION

The present invention provides a surface light source for generating a light having an enhanced brightness to improve quality of an image.

The present invention also provides a method of manufacturing the above-mentioned surface light source.

The present invention still provides a liquid crystal display (LCD) device having the above-mentioned surface light source.

In accordance with one aspect of the present invention, a surface light source device includes a body and a power supply member. The body includes a first substrate, a second substrate and at least one space-dividing member formed between the first and second substrates. The first substrate has first fluorescent patterns to convert an invisible ray into a visible ray. The first fluorescent patterns are arranged in parallel by a first interval that is in parallel. The second substrate corresponds to the first substrate. The space-dividing members are interposed between the first and second substrates to provide discharge spaces between the first and second substrates. Each of the space-dividing members has a width less than the first interval so that the visible ray exits between the space dividing member and the first fluorescent pattern. The space-dividing member is arranged two adjacent fluorescent patterns. The power supply member generates the invisible ray in the discharge spaces.

In accordance with another aspect of the present invention, in a method of manufacturing a surface light source device, at least two first fluorescent patterns for converting an invisible ray into a visible ray are formed on a first substrate. The first fluorescent patterns are disposed by a first interval. A space-dividing member is disposed between two adjacent first fluorescent patterns. A plurality of the space-dividing members may be formed. The space-dividing members are formed on a second substrate corresponding to the first substrate. Each of the space-dividing members has a width less than the first interval. The first and second substrates are assembled to form a body including discharge spaces therein. A power supply member for generating the invisible ray in the discharge space is formed on the body.

In accordance with still another aspect of the invention, an LCD device includes a surface light source device having a body and a power supply member, and an LCD panel. The body of the surface light source includes a first substrate, a second substrate facing with the first substrate, and a space-dividing member. The first substrate has first fluorescent patterns to convert an invisible ray into a visible ray. The first fluorescent patterns are formed in parallel by a first interval. The space-dividing member is interposed between the first and second substrates to form a discharge space. The space-dividing member has a width less than the first interval so that the visible ray is emitted through between the space-dividing members and the first fluorescent patterns. A power supply member generates the invisible ray in the discharge space. The LCD panel converts the visible ray into an image including information using a liquid crystal thereof.

According to the present invention, a surface light source enhances brightness of a visible ray and reduces power consumption to generate the visible ray. Therefore, the surface light source may generate the visible ray having enhanced brightness so that an LCD device including the surface light source may improve an image display quality.

### BRIEF DESCRIPTION OF THE DRAWINGS

The above features and other advantages of the present invention will become more apparent by describing the preferred embodiments thereof in detail with reference to the accompanying drawings, in which:

FIG. 1 is a partially cut-out perspective view illustrating a surface light source in accordance with one embodiment of the present invention;

FIG. 2 is a cross-sectional view illustrating the surface light source taken along a line I-I′ in FIG. 1;

FIG. 3 is an enlarged cross-sectional view illustrating a portion ‘B’ in FIG. 2;

FIG. 4 is a schematic plan view illustrating first fluorescent patterns formed on a second face of a first substrate in FIG. 1;

FIG. 5 is a schematic plan view illustrating a first substrate having first fluorescent patterns in accordance with one embodiment of the present invention;

FIG. 6 is a schematic plan view illustrating space-dividing members in FIG. 1;

FIG. 7 is a schematic plan view illustrating space-dividing members in accordance with one embodiment of the present invention;

FIG. 8 is a cross-sectional view illustrating a surface light source in accordance with one embodiment of the present invention;

FIG. 9 is an enlarged cross-sectional view illustrating a portion “C” in FIG. 8;

FIG. 10 is a schematic cross-sectional view illustrating a surface light source in accordance with one embodiment of the present invention;

FIG. 11 is an enlarged cross-sectional view illustrating a portion “D” in FIG. 10;

FIG. 12 is a schematic cross-sectional view illustrating a method of manufacturing a first substrate in accordance with one embodiment of the present invention;

FIG. 13 is a schematic cross-sectional view illustrating a method of manufacturing a second substrate in accordance with one embodiment of the present invention;

FIG. 14 is a schematic cross-sectional view illustrating a method of assembling the first substrate, the second substrate and a sealing member in accordance with one embodiment of the present invention;

FIG. 15 is a schematic cross-sectional view illustrating a method of forming a power supply member on a body of a surface light source in accordance with one embodiment of the present invention; and

FIG. 16 is an exploded perspective view illustrating a liquid crystal display device in accordance with one embodiment of the invention.

### DESCRIPTION OF THE EMBODIMENTS

It should be understood that the embodiments of the present invention described below may be varied modified in many different ways without departing from the inventive principles disclosed herein, and the scope of the present invention is therefore not limited to these particular following embodiments. Rather, these embodiments are provided so that this disclosure will be thorough and complete, and will fully convey the concept of the invention to those skilled in the art by way of example and not of limitation.

Hereinafter, the embodiments of the present invention will be explained with reference to the accompanying drawings. In the following drawings, like reference numerals identify similar or identical elements.

Surface Light Source

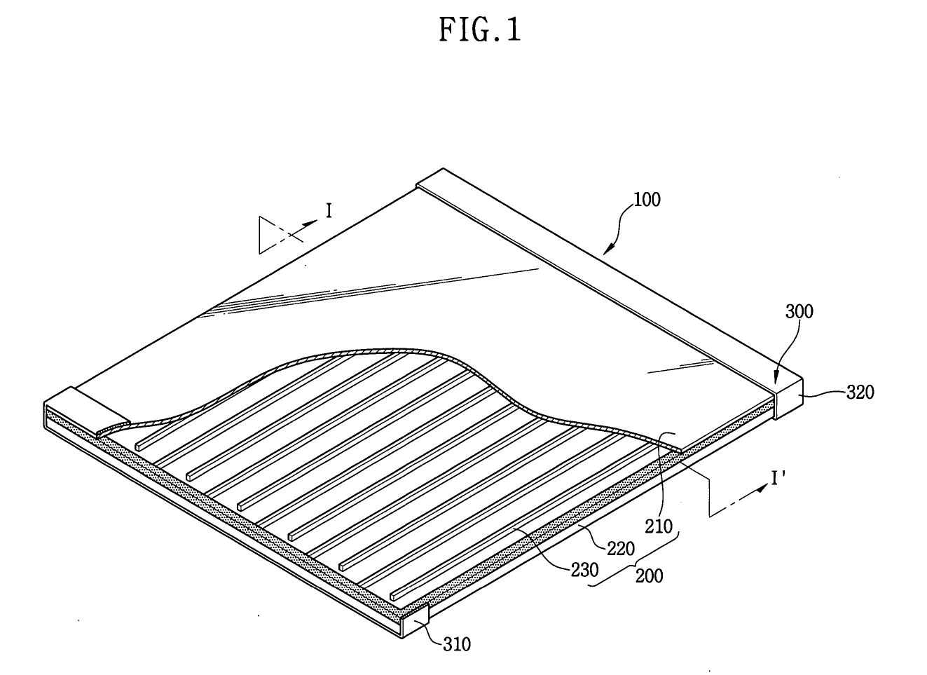

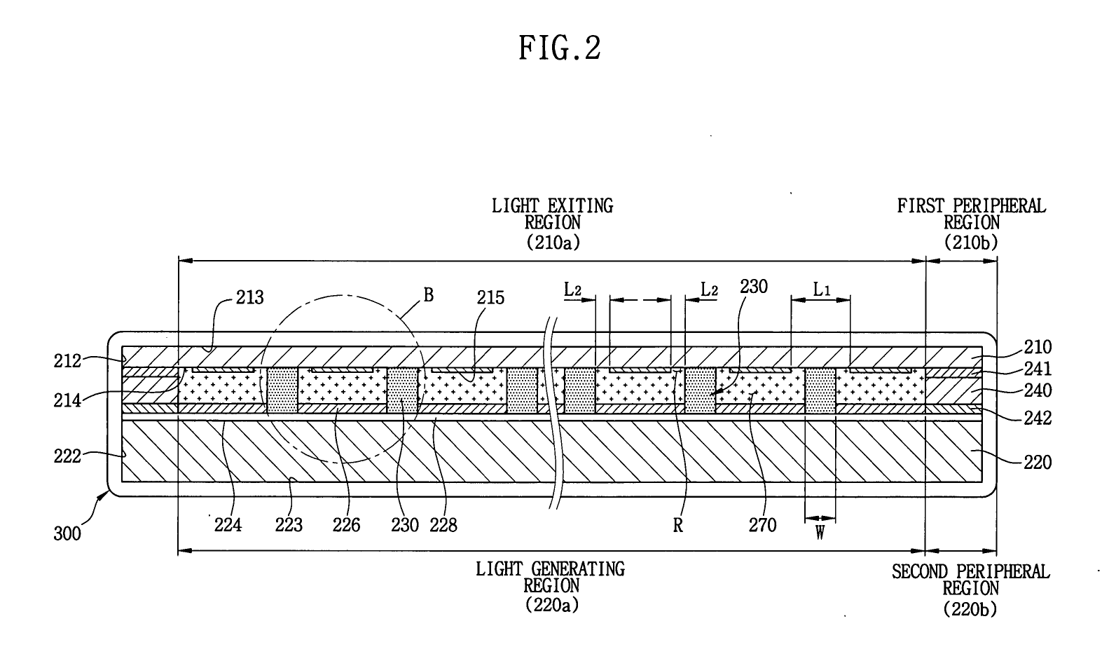

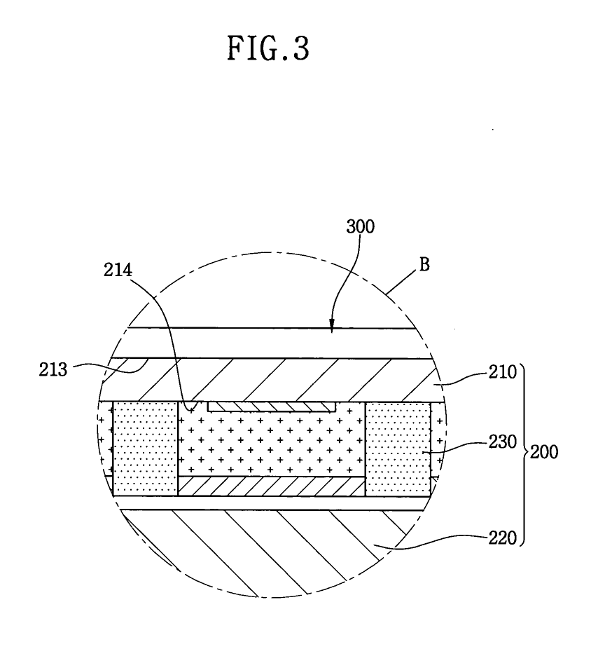

FIG. 1 is a partially cut-out perspective view illustrating a surface light source in accordance with one embodiment of the present invention. FIG. 2 is a cross-sectional view illustrating the surface light source taken along a line I-I′ in FIG. 1. FIG. 3 is an enlarged cross-sectional view illustrating a portion ‘B’ in FIG. 2.

Referring FIGS. 1 to 3, a surface light source 100 includes a body 200 and a power supply member 300.

The body 200 has a first substrate 210, a second substrate 220 corresponding to the first substrate 220, and at least one space-dividing member 230 interposed between the first and second substrates 210 and 230.

Visible rays may be transmitted through the first substrate 210, whereas invisible rays such as ultraviolet rays may be not transmitted through the first substrate 210. The first substrate 210 may include a glass plate. Alternatively, the first substrate 210 may include an ultraviolet ray absorbing plate that efficiently blocks the ultraviolet rays transmitting therethrough better than the glass plate.

Referring now to FIGS. 2 and 3, the first substrate 210 includes a plurality of first side faces 212, a first face 213 and a second face 214. The first face 213 is connected to the first side faces 212 and the second face 214 corresponding to the first face 213.

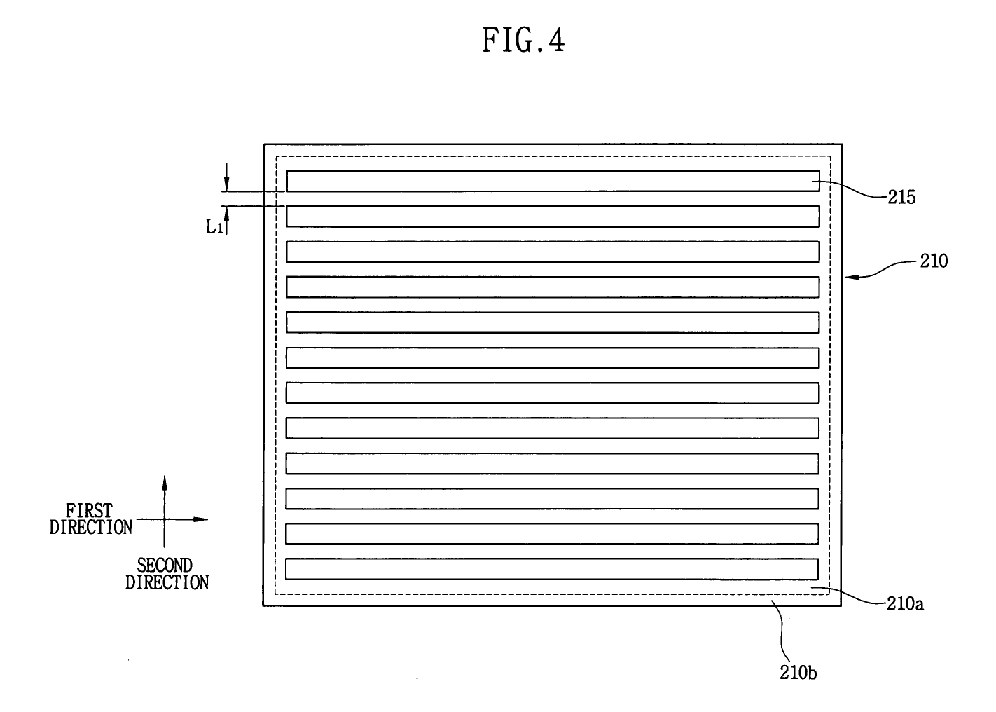

FIG. 4 is a schematic plan view illustrating first fluorescent patterns formed on a second face of a first substrate in FIG. 1.

Referring to FIGS. 3 and 4, the first substrate 210 includes a light exiting region 210a and a first peripheral region 210 enclosing the light exiting region 210a. At least one first fluorescent pattern 215 is disposed on the light exiting region 210a of the first substrate 210. Particularly, the first fluorescent pattern 215 is disposed on the second face 214 of the first substrate 210. The first fluorescent pattern 215 has a rectangular bar shape having a thickness of about 10 μm. In this embodiment, at least two first fluorescent patterns 215 may be extended on the first substrate 210 along a first direction. Additionally, the two first fluorescent patterns 215 are disposed in parallel on the first substrate 210 along a second direction substantially perpendicular in the first direction. Here, two adjacent first fluorescent patterns 215 are disposed by a first interval L1. The first fluorescent patterns 215 convert the invisible rays such as the ultraviolet rays into the visible rays. The first fluorescent patterns 215 may include red fluorescent material, green fluorescent material and blue fluorescent material. To generate white rays from the first fluorescent patterns 215, the red, green and blue fluorescent materials are mixed by substantially identical weight percent.

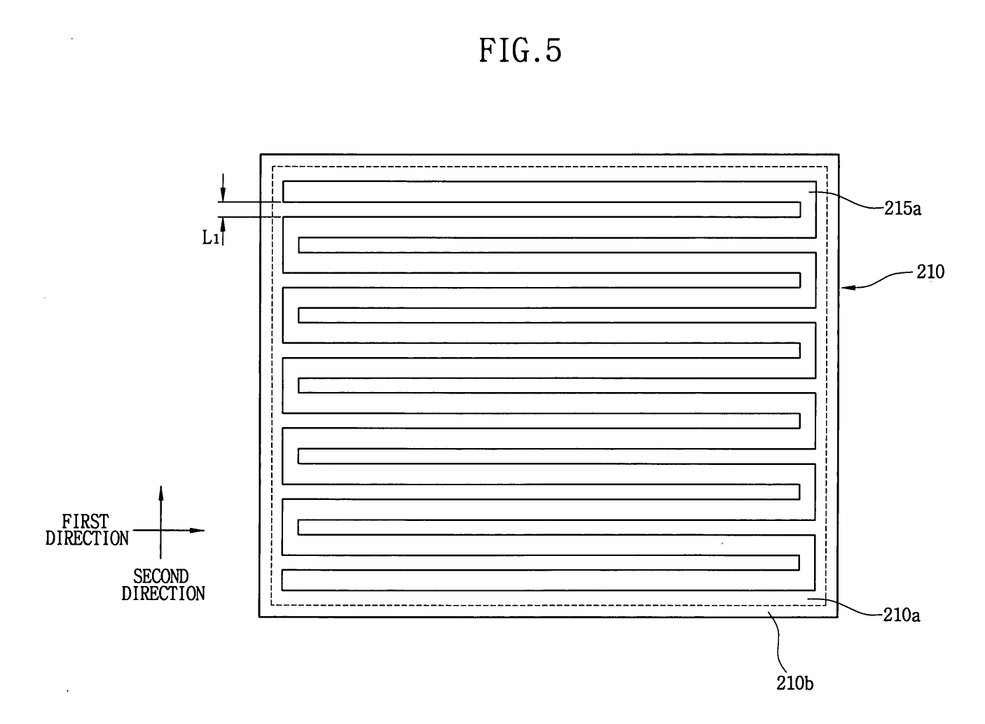

FIG. 5 is a schematic plan view illustrating a first substrate having first fluorescent patterns in accordance with one embodiment of the present invention.

Referring to FIG. 5, the first fluorescent patterns 215a have a rectangular bar shape and a thickness of about 10 μm. At least two adjacent first fluorescent patterns 215a are continuously formed and extended on the first substrate 210 in the first direction. In addition, the first fluorescent patterns 215 are disposed in parallel along the second direction. An interval between the two adjacent first fluorescent patterns 215 corresponds to the first interval L1. Here, the first fluorescent patterns 215a are connected to each other so that the first fluorescent patterns 215a are entirely formed to have a serpentine type construction. Referring to FIGS. 1 and 2, the second substrate 220 faces with the first substrate 210. The second substrate 220 may include the transparent plate. Alternatively, the second substrate 200 may include the opaque plate. In this embodiment, the second substrate 220 includes the transparent plate.

Referring to FIG. 2, the second substrate 220 includes a plurality of second side faces 222, a third face 224 and a fourth face 223. The third face 224 is connected to the second side faces 222. The third face 224 corresponds to the fourth face 223. The third face 224 of the second substrate 220 is divided into a light generating region 220a and a second peripheral region 220b. The second peripheral region 220b of the second substrate 220 encloses the light generating region 220a of the second substrate 220.

A sealing member 240 is interposed between the first peripheral region 210b of the first substrate 210 and the second peripheral 220b of the second substrate 220. The sealing member 240 combines the first substrate 210 with the second substrate 220. A space provided between the first substrate 210 and the second substrate 220 is sealed using the sealing member 240. The sealing member 240 prevents leakage of a discharge gas from the space formed between the first substrate 210 and the second substrate 220.

The sealing member 240 has a shape substantially identical to that of the first peripheral region 210a or the second peripheral region 220b. That is, the sealing member 240 has a rectangular frame shape including an opening that corresponds to the light exiting region 210a and the light generating region 220a.

A first adhesive 241 is interposed between a first end portion of the sealing member 240 and the first peripheral region 210b of the first substrate 210. A second adhesive 242 is interposed between a second end portion of the sealing member 240 and the second peripheral region 220b of the second substrate 220. Using the first adhesive 241 and the second adhesive 242, the sealing member 240 combines the first substrate 210 with the second substrate 220.

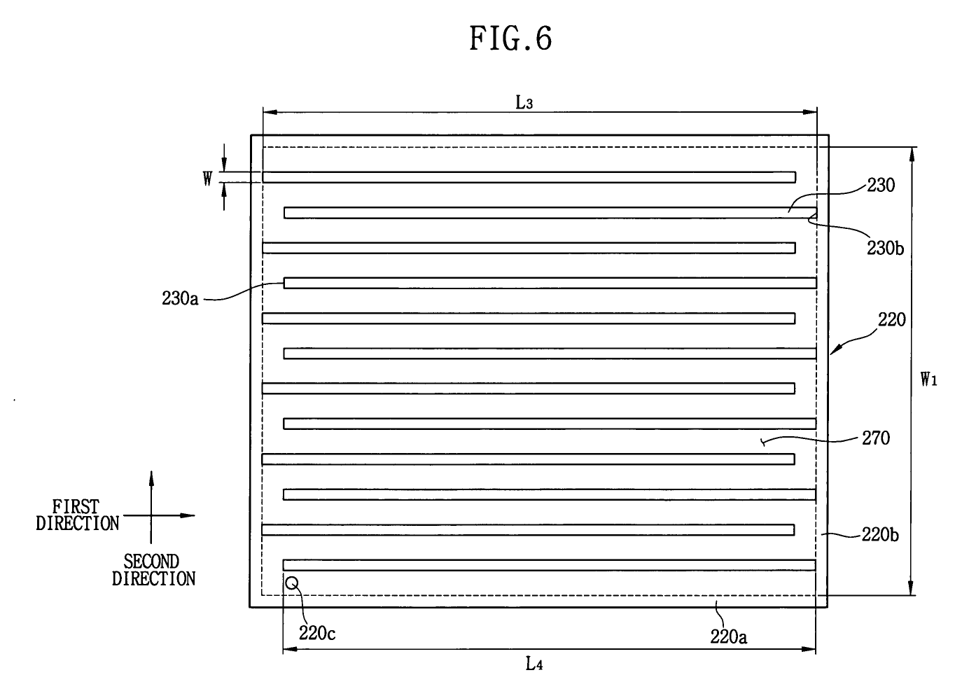

FIG. 6 is a schematic plan view illustrating space-dividing members in FIG. 1.

Referring to FIGS. 2 and 6, the space-dividing members 230 are disposed between the first substrate 210 and the second substrate 220. The space-dividing members 230 divide the space formed between the first and second substrates 210 and 220 into several sub-spaces so that a plurality of discharge spaces 270 is formed between the first substrate 210 and the second substrate 220.

Each of the space-dividing members 230 has a rod shape, and is extended in the light generating region 220a of the second substrate 220 along the first direction corresponding to a horizontal direction with respect to the second substrate 220. In addition, each of the space-dividing members 230 is disposed between two adjacent first fluorescent patterns 215. Each of the space-dividing members 230 has a width W substantially less than the first interval L1 between two adjacent fluorescent patterns 215. Opened regions R are formed at both sides of the space-dividing member 230. The second intervals L2 between the space-dividing member 230 and two adjacent fluorescent patterns disposed at both sides of the space-dividing member are substantially same.

Referring to FIG. 2, the space-dividing members 230 divide the light generating region 220a into a plurality of discharge spaces 270 such that the discharge spaces 270 are connected to one after another. Thus, a pressure of the discharge gas in the discharge spaces 270 becomes uniform so that amount difference of the invisible rays that is generated in the discharge spaces 260 may be minimized.

Referring to FIG. 4, when the light generating region 220a has a first length L3 in the first direction and a width W1 along the second direction. Each of the space-dividing members 230 has a second length L4, and each of the space-dividing members has a first end portion 230a and a second end portion 230b corresponding to the first end portion 230a. The second length L4 of the space-dividing member 230 is substantially shorter than the first length L3 of the light generating region 220a of the second substrate 220. An odd numbered space-dividing member of the first end portion 230a of the space-dividing members 230 and an even numbered space-dividing member of the second end portion 230b of the space-dividing members 230 are alternately connected to an inner face of the sealing member 240. In FIG. 4, a reference numeral 220c indicates a discharge gas supply hole for providing the discharge spaces 270 with the discharge gas.

The entire discharge spaces 270 have a serpentine type construction in accordance with arrangement of the odd numbered space-dividing members and the even numbered space-dividing members. Each of the discharge spaces 270 includes the discharge gas so as to generate the invisible ray. Examples of the discharge gas may include mercury (Hg), argon (Ar), neon (Ne), krypton (Kr), xenon (Xe), etc.

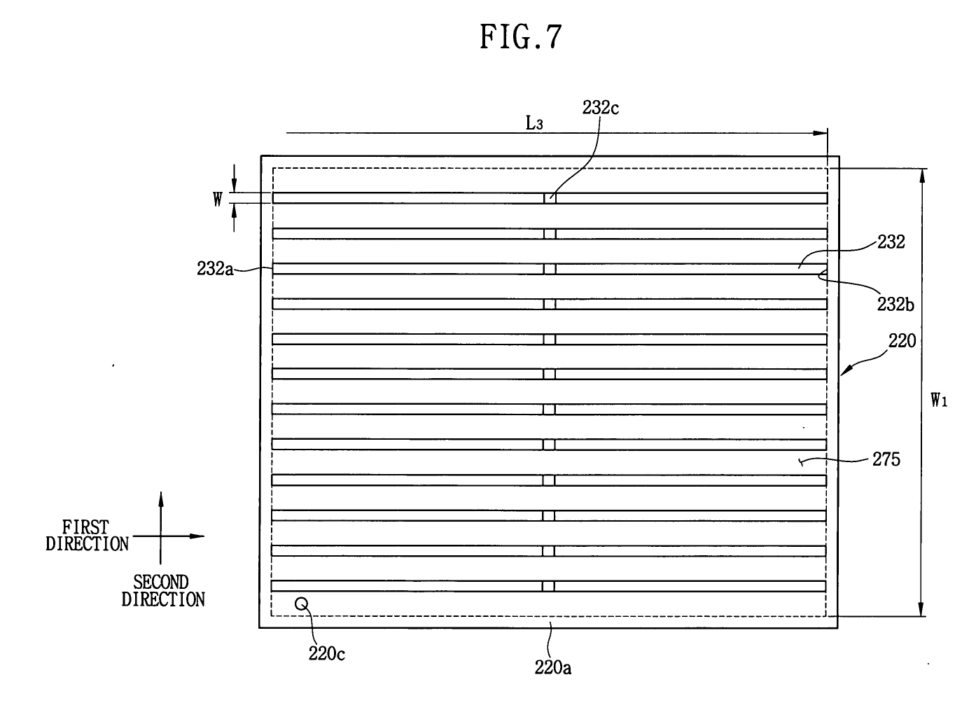

FIG. 7 is a schematic plan view illustrating space-dividing members in accordance with one embodiment of the present invention.

Referring to FIGS. 2 and 7, space-dividing members 232 divide the light generating region 220a of the second substrate 220 into a plurality of discharge spaces 275 that are isolated from one another.

A first length L3 of the light generating region 220a is in the first direction and a first width W1 of the light generating region 220a is in the second direction. A second length L4 of the space-dividing member 232 between a first end portion 230a and a second end portion 230b opposed to the first end portion 230a is substantially identical to the first length L3 of the light generating region 220a of the second substrate 220. Thus, the first and second end portions 232a and 232b of the space-dividing member 232 are connected to an inner face of the sealing member 240.

When the discharge spaces 275 are separated from one another by the space-dividing members 232, a pressure of a discharge gas filled in the discharge spaces 275 may not be uniformly controlled.

To uniformly control the pressure of the discharge gas in the discharge spaces 275, a through hole 232c is formed through each of the space-dividing member 232. Therefore, the pressure of the discharge gas in the discharge spaces 275 may be uniformly controlled by the through holes 232c. After the discharge gas is introduced in the discharge spaces 275, the through holes 232c may be sealed using discharge gas flow preventing members having a rod shape so that flow of the discharge gas in the discharge spaces 275 may be prevented.

Referring to FIG. 2, the second substrate 220 having the space-dividing members 230 may include second fluorescent patterns 226 to convert the invisible rays into the visible rays. In this embodiment, the second fluorescent patterns 226 are disposed on the second substrate 220 among the space-dividing members 230. Alternatively, the second fluorescent patterns 226 may be formed on side faces of the space-dividing members 230 and on the second substrate 220 among the space-dividing members 230. Here, the second fluorescent patterns 226 have a thickness thicker than those of the first fluorescent patterns 215. For example, the second fluorescent patterns 226 have a thickness of about 40 to about 50 μm.

The second substrate 220 may further include a light reflective layer 228. The light reflective layer 228 is disposed between the second substrate 220 and the second fluorescent patterns 226. The light reflective layer 228 is positioned on the second substrate 220 among the space-dividing members 230. The light reflective layer 228 reflects the visible ray generated in the discharge spaces 270 toward the first substrate 210 so that the amount of the visible ray emitted from the first substrate 210 may be greatly increased.

Referring to FIGS. 1 and 2, the power supply member 300 generates the invisible rays from the discharge gas filled in the body 200. The power supply member 300 is disposed on the body 200 for generating the invisible rays from the discharge gas. Alternatively, the power supply member 300 may be disposed in the body 200. In this embodiment, the power supply member 300 is disposed on the body 200. In case that the power supply member 300 is disposed on the body 200, a driving voltage level for generating discharge in the body 200 may be lowered so that the surface light source 100 may have low power consumption.

The power supply member 300 includes a first electrode 310 and a second electrode 320. A first driving voltage is applied to the first electrode 310 and a second driving voltage is applied to the second electrode 320. Here, the first driving voltage and the second driving voltage provide electric fields that sufficiently generate a discharge in the discharge spaces 270 between the first electrode 310 and the second electrode 320.

When the power supply member 300 generates the electric fields in the discharge spaces 270 to cause the discharge in the discharge spaces 270, the discharge gas is ionized by the discharge generated in the discharge spaces 270 so that the invisible rays are generated from the discharge gas.

In FIG. 2, intensity of the invisible rays generated from each of the discharge spaces 270 provided between the space-dividing members 230 may decrease near the space-dividing members 230, whereas the intensity of the invisible rays may increase apart from the space-dividing members 230. Intensity of the visible rays converted from the invisible rays by the first fluorescent patterns 215 also may decrease near the space-dividing members 230, whereas the intensity of the visible rays may increase apart from the space-dividing members 230.

According to the present invention, the first fluorescent patterns 215 are not formed near the space-dividing members 230 where the intensity of the invisible rays is relative weak so that the visible rays in the discharge spaces 270 are emitted through between the space-dividing members 230 and the first fluorescent patterns 215. As a result, the surface light source 100 may have improved brightness by about 15 percent comparing to a convention surface light source. Here, ultraviolet rays may be emitted together with the visible rays through between the space-dividing members 230 and the first fluorescent patterns 215 to damage an orientation layer or liquid crystal of an LCD device. However, because intensity of the emitted ultraviolet rays is relatively weak and the first substrate 210 may absorb the emitted ultraviolet rays, the ultraviolet rays may not pass the first substrate 210, whereas the visible rays may pass the first substrate 210.

In the present embodiment, fluorescent patterns for converting invisible rays into visible rays may not be formed at positions of a surface light source, which the invisible rays have intensity lower than that of the visible rays. Thus, the surface light source may have enhanced brightness to thereby improve an image display quality.

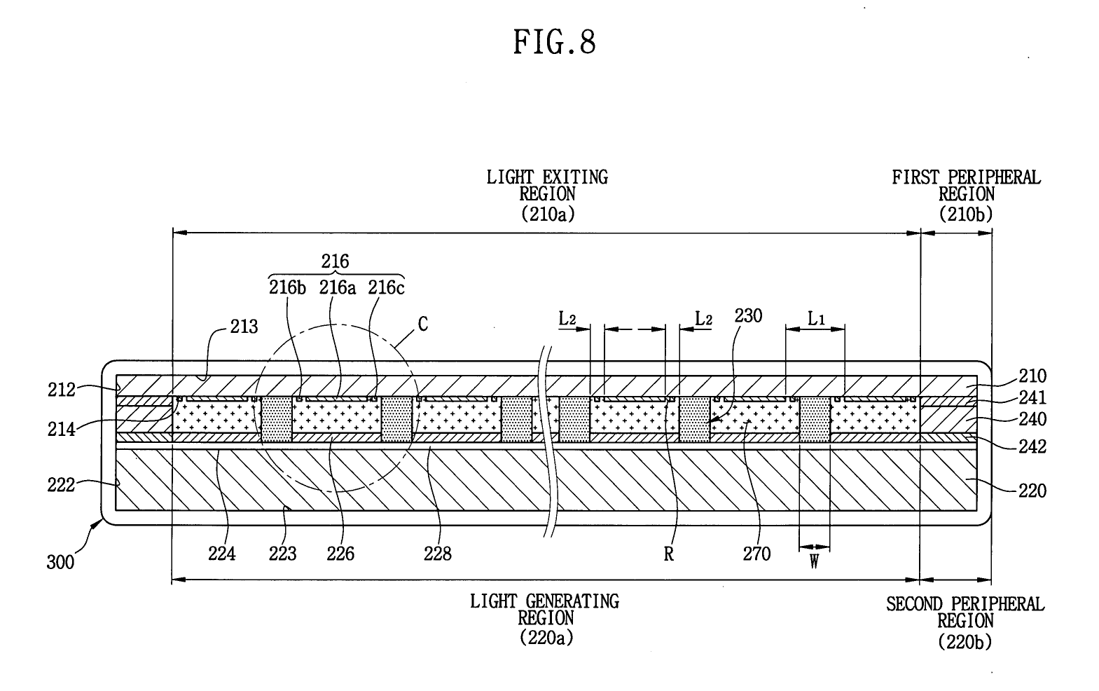

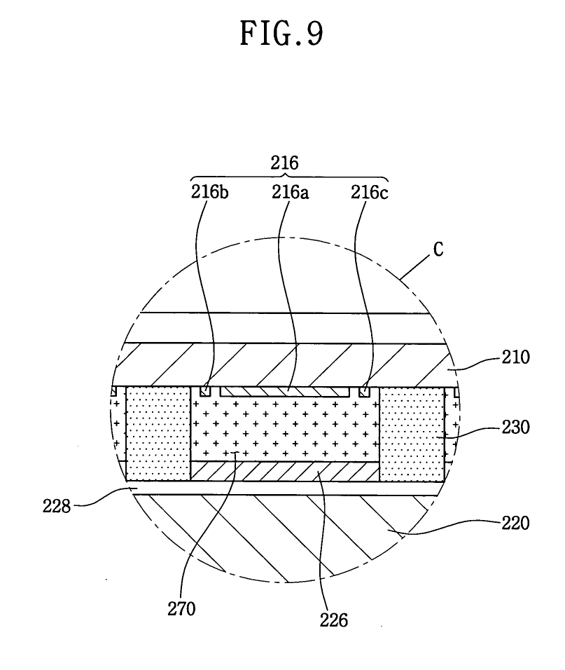

FIG. 8 is a cross-sectional view illustrating a surface light source in accordance with one embodiment of the present invention, and FIG. 9 is an enlarged cross-sectional view illustrating “C” in FIG. 8.

The surface light source of the present embodiment includes elements substantially identical to those of the surface light source 100 in FIG. 2 except for first fluorescent patterns. Thus, any further explanation of the identical elements is omitted.

Referring to FIGS. 8 and 9, each of first fluorescent patterns 216 may include at least two, preferably at least three fluorescent pattern portions between a pair of adjacent space-dividing members 230. The fluorescent pattern portions are separated from one another. For example, the first fluorescent pattern 216 includes a first fluorescent pattern portion 216a, a second fluorescent pattern portion 216b, and a third fluorescent pattern portion 216c.

The first fluorescent pattern portion 216a is disposed on a first substrate 210, and is spaced apart from the pair of space-dividing members 230.

The second fluorescent pattern portion 216b is disposed between one end of the first fluorescent pattern portion 216a and one of the space-dividing members 230. In this embodiment, one of second fluorescent pattern portion 216b may be formed. Alternatively, at least two second fluorescent pattern portions 216b may be formed between both ends of the first fluorescent pattern portion 216a and the space-dividing members 230.

The third fluorescent pattern portion 216c is disposed between another end of first fluorescent pattern portion 216a and another one of the space-dividing members 230. In this embodiment, the third fluorescent pattern portion 216c symmetrically corresponds to the second fluorescent pattern portion 216b by interposing the first fluorescent pattern portion 216a therebetween. Alternatively, at least two third fluorescent pattern portions 216c may be formed between both ends of the first fluorescent pattern portion 216a and the space-dividing members 230.

As described above, the first, second and third fluorescent pattern portions 216a, 216b and 216c are disposed between the space-dividing members 230 so that the first, second and third fluorescent pattern portions 216a, 216b and 216c may enhance brightness of the visible rays generated in discharge spaces and may improve uniformity of the brightness of the visible rays.

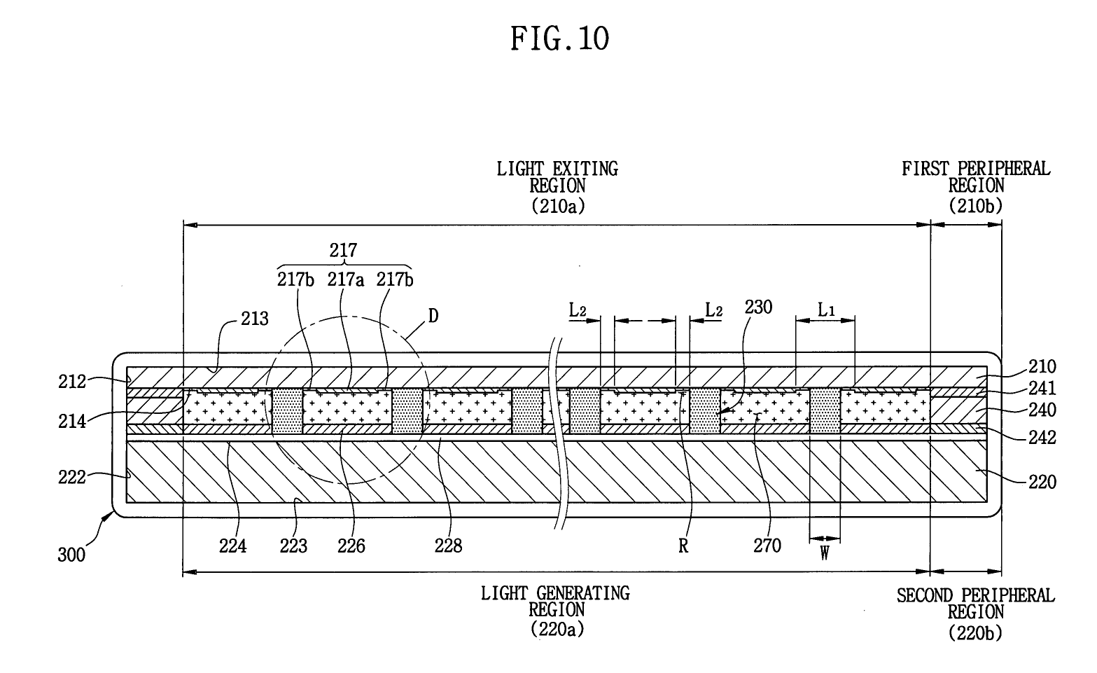

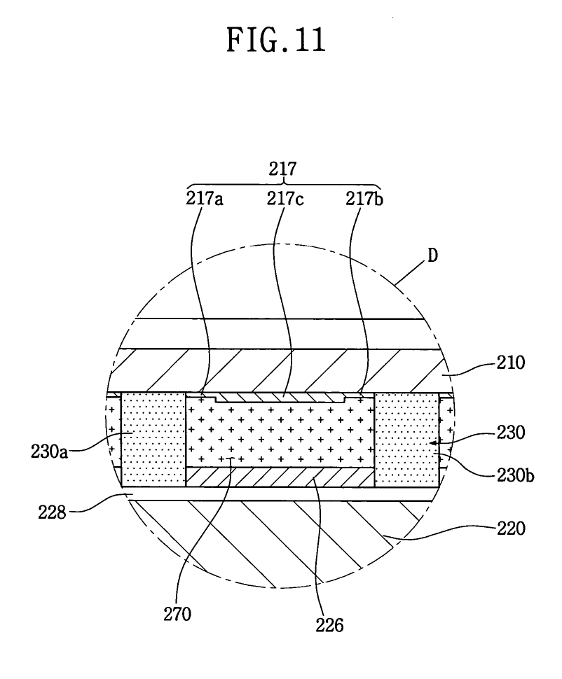

FIG. 10 is a schematic cross-sectional view illustrating a surface light source in accordance with one embodiment of the present invention, and FIG. 11 is an enlarged cross-sectional view illustrating a portion “D” in FIG. 10.

The surface light source of this embodiment includes elements substantially identical to those of the surface light source 100 in FIGS. 1 and 2 except for first fluorescent patterns. Thus, any further explanation for the identical elements will be omitted.

Referring to FIGS. 10 and 11, each of first fluorescent patterns 217 includes a main pattern portion 217c, a first fluorescent sub-pattern portion 217a and a second fluorescent sub-pattern portion 217b.

The first fluorescent pattern 217 is disposed between a pair of adjacent space-dividing members 230. In this embodiment, the pair of adjacent space-dividing members defines the first fluorescent space-dividing member 230a and the second fluorescent space-dividing member 230b.

The main pattern portion 217c is separated from the first and second space-dividing members 230a and 230b. The main pattern portion 217c has a first thickness.

The first fluorescent sub-pattern 217a is extended from the main pattern portion 217c so as to make contact with the first space-dividing member 230a adjacent to a first end portion of the first fluorescent pattern 217. The first fluorescent sub-pattern 217a has a second thickness thinner than the first thickness of the main pattern portion 217c.

The second fluorescent sub pattern 217b is extended from the main pattern portion 217c so as to make contact with the second space-dividing member 230b adjacent to a second end portion corresponding to the first end portion of the first fluorescent pattern 217. The second fluorescent sub-pattern 217b has the second thickness thinner than the first thickness of the main pattern portion 217c.

In this embodiment, the first and second fluorescent sub-pattern portions 217a and 217b have substantially identical thickness. When the first fluorescent pattern portion 216a has a thickness of about 10 μm, the first and second fluorescent sub-pattern portions 217b and 217c have thickness of below about 10 μm.

As describe above, ultraviolet rays are converted into visible rays by the first fluorescent pattern 217 near the space-dividing members 230, and the visible rays may be efficiently emitted from the first substrate 210, thereby improving brightness of the visible rays and uniformity of the brightness of the visible rays.

Method of Manufacturing a Surface Light Source

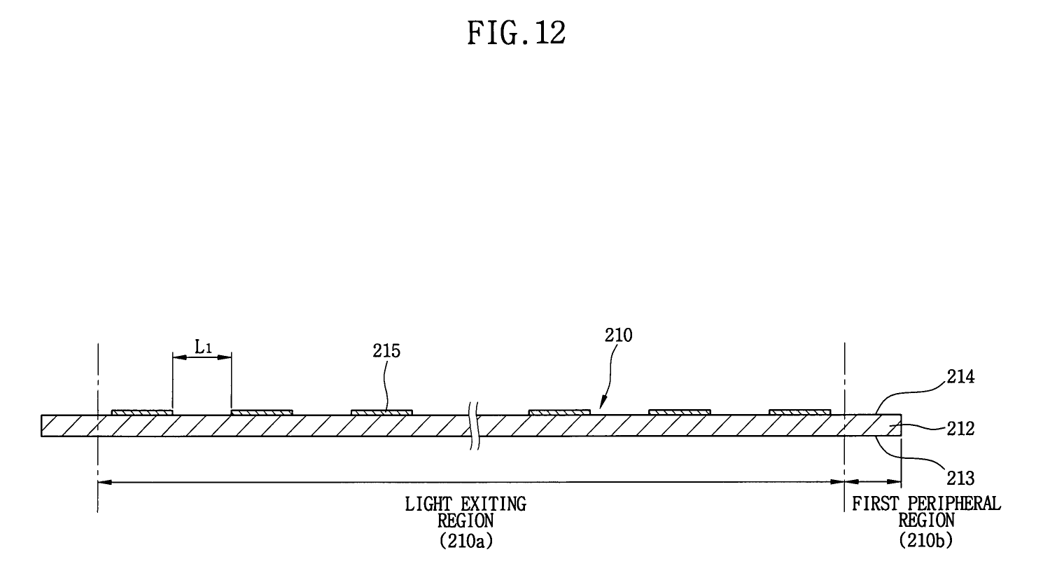

FIG. 12 is a schematic cross-sectional view illustrating a method of manufacturing a first substrate in accordance with one embodiment of the present invention.

Referring to FIG. 12, first fluorescent patterns 215 are partially formed in a light exiting region 210a of a second face 214 of a first substrate 210 by a printing process such as a silk-screen printing process.

The first fluorescent patterns 215 are formed on the first substrate 210 to have rectangular bar shapes along a first direction. At least two adjacent first fluorescent patterns 215 are formed on the second face 214 of the first substrate 210. Each of the first fluorescent patterns 215 has a thickness of about 10 μm. The first fluorescent patterns 215 are separated from each other by an interval L1.

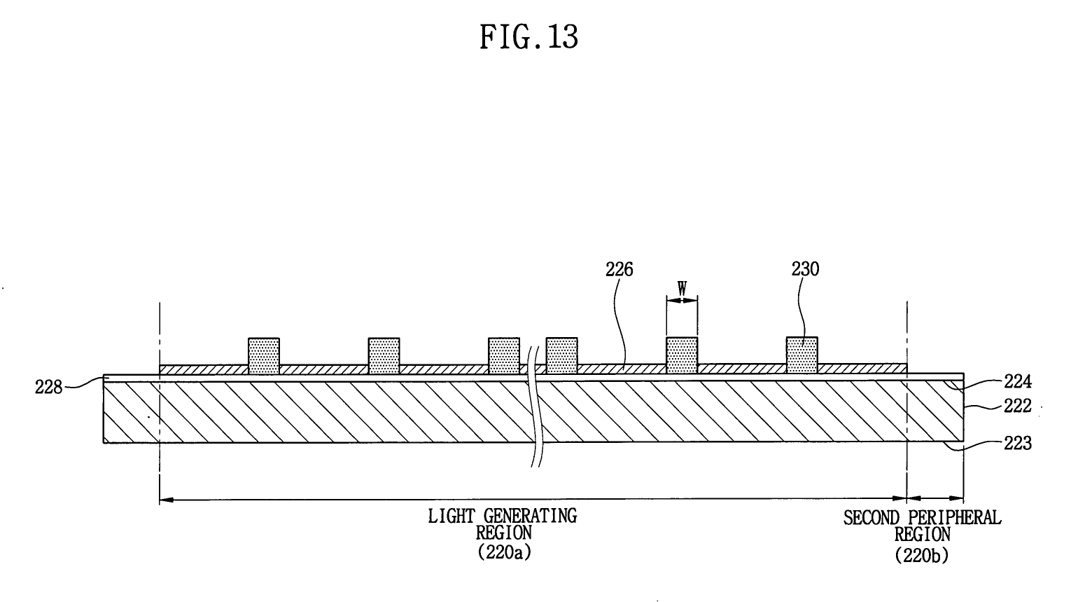

FIG. 13 is a schematic cross-sectional view illustrating a method of manufacturing a second substrate in accordance with one embodiment of the present invention.

Referring to FIG. 13, a reflective layer 228 is formed on a third face 224 of a second substrate 220. The reflective layer 228 may be formed on the third face 224 by a chemical vapor deposition (CVD) process or a sputtering process. Alternatively, the reflective layer 228 may be formed via spraying liquid metal onto the third face 224 of the second substrate 220.

Space-dividing members 230 are formed on the third face 224 including the reflective layer 228 thereon. The space-dividing members 230 are formed using transparent material having reflowability or opaque material having reflowability. The reflowable material may be sprayed on the third face 224 to form the space-dividing members 230 having a predetermined height.

Each of the space-dividing members 230 has a width W smaller than the first interval L1 between the first fluorescent patterns 215. The space-dividing members 230 are arranged along the first direction.

The space-dividing members 230 disposed on the third face 224 are disposed between the first fluorescent patterns 215 when the first substrate 210 is combined to the second substrate 220.

Second fluorescent patterns 226 may be formed on the third face 224 before forming the space-dividing members 230 on the third face 224. The second fluorescent patterns 226 are formed on an entire surface of the light reflective layer 228. Alternatively, the second fluorescent patterns 226 are formed on a portion of the reflective layer 228 where the space-dividing members 230 are not positioned.

Each of the second fluorescent patterns 226 has a thickness thicker than that of the first fluorescent patterns 215. For example, the second fluorescent pattern 226 has a thickness of about 40 to about 50 μm.

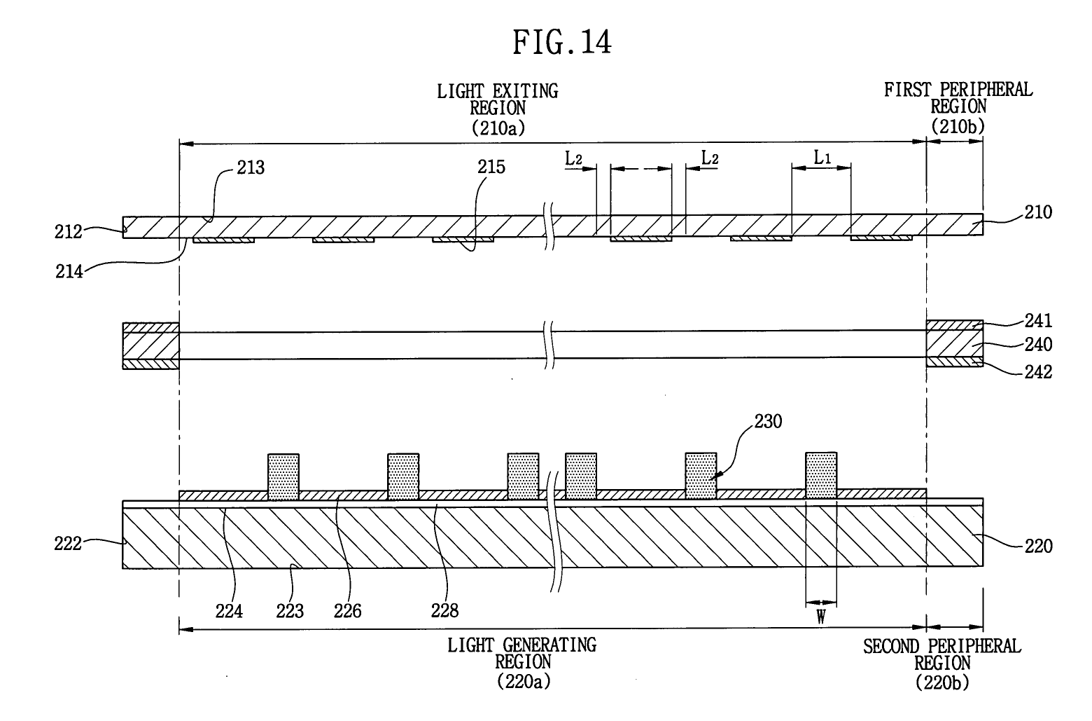

FIG. 14 is a schematic cross-sectional view illustrating a method of assembling the first substrate, the second substrate and a sealing member in accordance with one embodiment of the present invention.

Referring to FIG. 14, the second face 214 of the first substrate 210 and the third face 224 of the second substrate 220 are aligned to face each other. The space-dividing members 230 formed on the third face 224 are aligned between the first fluorescent patterns 215 formed on the second face 214.

A sealing member 240 is disposed between the first and second substrates 210 and 220. The sealing member 240 provides a space between the first and second substrates 210 and 220, and seals the space therebetween. The sealing member 240 for sealing the space is disposed between a first peripheral region 210b enclosing a light exiting region 210a of the first substrate 210 and a second peripheral region 220b enclosing a light generating region 220a of the second substrate 220. The sealing member 240 seals the space between the first and second substrates 210 and 220 so as to prevent the leakage of a discharge gas in the space.

To prevent the discharge gas from leaking out of the space between the first and second substrates 210 and 220, a first adhesive 241 is formed between an upper face of the sealing member 240 and the first peripheral region 210b, and a second adhesive 241 is formed between a bottom face of the sealing member 240 and the second peripheral region 220b.

The first substrate and second substrates 210 and 220 are assembled using the sealing member 240 interposed therebetween so that a body 200 of the surface light source is formed.

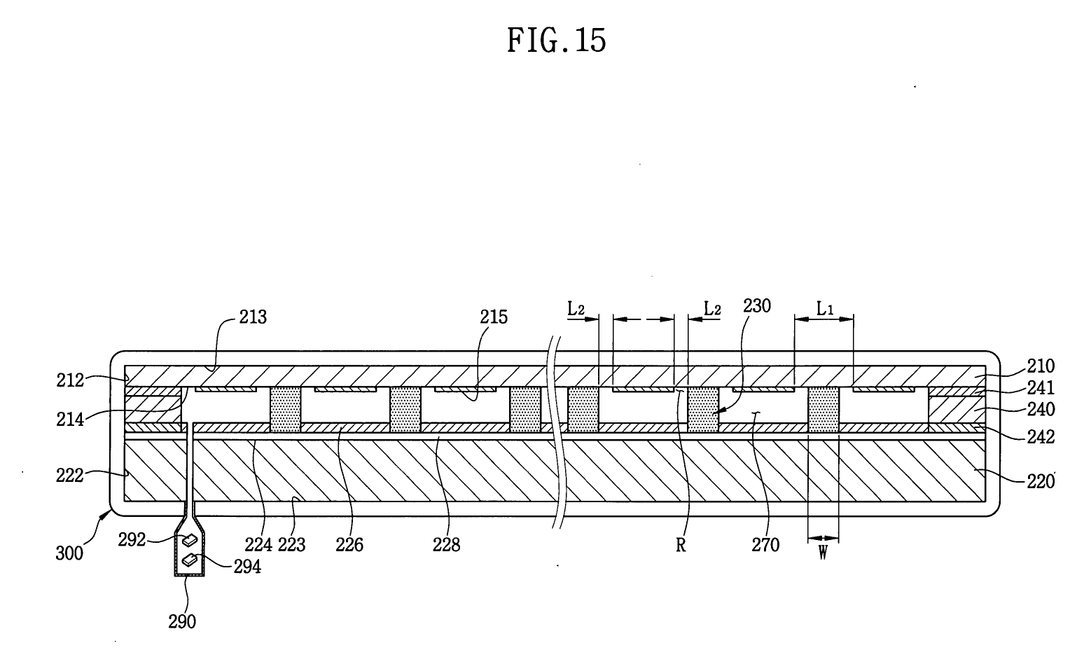

FIG. 15 is a schematic cross-sectional view illustrating a method of a power supply member on the body of the surface light source in accordance with one embodiment of the present invention.

Referring to FIG. 15, after the body 200 is prepared, a discharge gas is introduced into discharge spaces 270 formed in the body 200. To supply the discharge gas into the discharge spaces 270, a discharge gas supply unit 290 is connected to the discharge spaces 270. The discharge gas supply unit 290 may provide the discharge gas into the discharge spaces 270 by heating the discharge gas supply unit 290 using a radio frequency wave. The discharge gas supply unit 290 includes a discharge gas supply member 292 and a getter 294. The discharge gas supply member 292 provides the discharge gas into the discharge spaces 270. The getter 294 absorbs oxygen, nitrogen, carbon monoxide, carbon dioxide and water in the discharge spaces 270.

A power supply member 300 is disposed on the body 200. The power supply member 300 generates an invisible ray from the discharge gas in the discharge spaces 270. The power supply member 300 may include a metal tape disposed on the body 200. Alternatively, the power supply member 300 may include melted metal, for example a melted solder disposed on the body 200. Further, the power supply member 300 may be formed on the body 200 by a plating process.

The power supply member 300 includes a first electrode 310 and a second electrode 320 to generate the invisible ray from the discharge gas in the discharge spaces 270.

The first and second electrodes 310 and 320 are disposed on the body 200. A first driving voltage and a second driving voltage are applied to the first electrode 310 and the second electrode 320, respectively. The first and second driving voltages have a sufficient potential difference to induce discharging in the discharge spaces 270.

Liquid Crystal Display Device

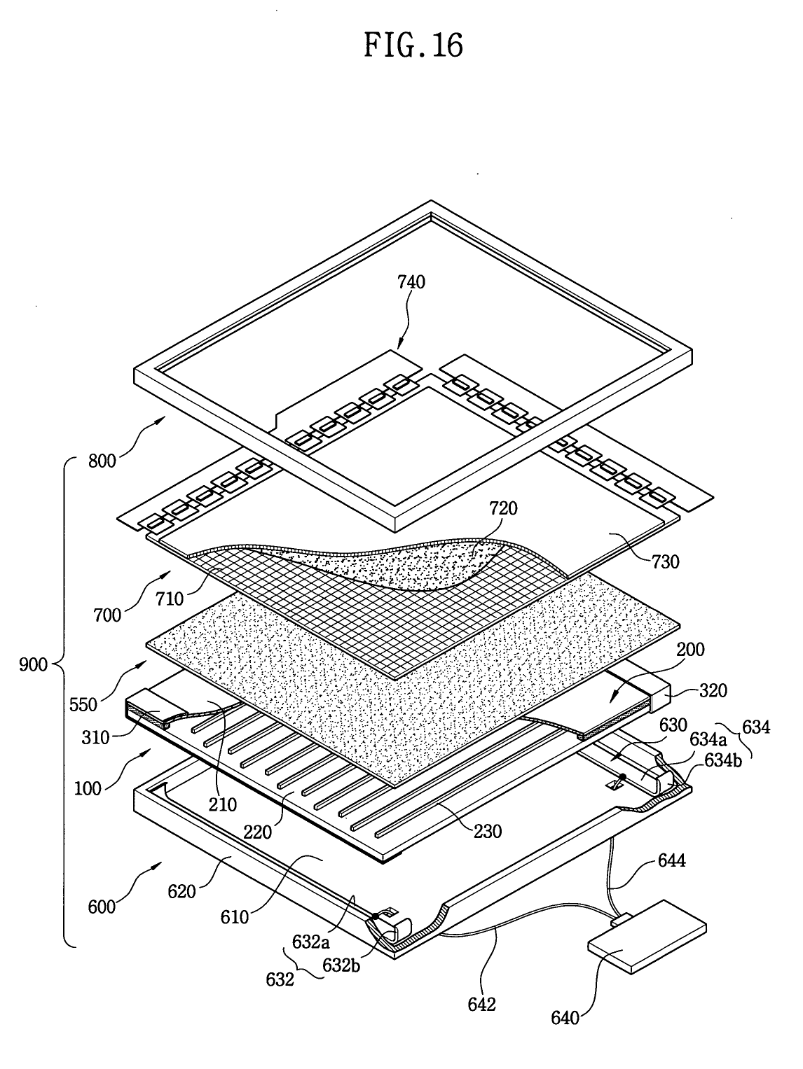

FIG. 16 is an exploded perspective view illustrating a liquid crystal display (LCD) device in accordance with one embodiment of the invention.

In this embodiment, the LCD device has a surface light source substantially identical to the above-described surface light source.

Referring to FIG. 16, an LCD device 900 includes a receiving container 600, a surface light source 100, an LCD panel 700 and a chassis 800.

The receiving container 600 includes a bottom face 610, a plurality of sidewalls 620, a discharge voltage supply module 630 and an inverter 640. The sidewalls 620 are disposed on an edge portion of the bottom face 600 to form a receiving space. The surface light source 100 and the LCD panel 700 are directly fixed by receiving container 600.

The bottom face 610 of the receiving container 600 has a size sufficient to receive the surface light source 100. The bottom face 610 has a shape substantially identical to the surface light source 100. For example, the bottom face 610 has a rectangular shape according to that of the light surface source 100.

The sidewalls 620 of the receiving container 600 are extended from the bottom face 610 so as to prevent the surface light source 100 from separating out of the receiving container 600.

The discharge voltage supply module 630 applies a discharge voltage to the voltage supply module 630 of the surface light source 100. The discharge voltage supply module 630 includes a first discharge voltage supply member 632 and a second discharge voltage supply member 634. The first discharge voltage supplying member 632 includes a first conductive body 632a, and a first conductive clip 632b formed on the first conductive body 632a. The second discharge voltage supply member 634 includes a second conductive body 634a, and a second conductive clip 634b formed on the second conductive body 634a.

The discharge voltage supply module 630 including the first and second discharge voltage supply members 632 and 634 formed on the surface light source 100 is fixed by the first and second conductive clips 632b and 634b.

The inverter 640 applies the discharge voltage to the first and second discharge voltage supply members 632 and 634. A first power supply line 642 connects the inverter 640 to the first discharge voltage supply member 632, and a second power supply line 644 connects the inverter 640 to the second discharge voltage supply member 634.

The surface light source 100 includes a body 200 and a power supply member 300. The body 200 includes a first substrate 210, a second substrate 220, and space-dividing members 230. A plurality of first fluorescent patterns is disposed on the first substrate 210 in parallel. The space-dividing members 230 are disposed on the second substrate 220. Each of the space-dividing members 230 has a width less than an interval between the first fluorescent patterns 215. The space-dividing members 230 are extended in a direction substantially identical to that of the first fluorescent patterns 215. The space-dividing members 230 are disposed between the first fluorescent patterns 215. Thus, a visible ray generated in discharge spaces 270 passes between the space dividing members 230 and the first fluorescent patterns 215, thereby enhancing a brightness of the visible ray.

The LCD panel 700 converts the visible ray generated from the surface light source 100 into an image including information. To convert the visible rays into the image, the liquid crystal display panel 700 requires a thin film transistor (TFT) substrate 710, a liquid crystal layer 720, a color filter substrate 730 and a driving module 740.

The TFT substrate 710 includes pixel electrodes arranged in a matrix type, thin film transistors for applying driving voltages to the pixel electrodes, a gate line, and a data line.

The color filter substrate 730 includes a color filter facing the pixel electrodes formed on the TFT substrate 710, and a common electrode formed thereon.

The liquid crystal layer 720 is interposed between the TFT substrate 710 and the color filter substrate 730.

The chassis 800 presses an edge portion of the color filter substrate 730 of the LCD panel 700, and a portion of the chassis 800 is combined with the receiving container 600. The chassis 800 prevents the fracture of the fragile LCD panel 700 due to a little impact or an external force. The chassis 800 also prevents the LCD panel 700 from separating out of the receiving container 600. A reference numeral 550 indicates an optical diffusion member for diffusing the visible ray emitted from the surface light source 100.

According to the present invention, a surface light source enhances the brightness of a visible ray, and reduces a power consumption to generate the visible ray. Therefore, the surface light source may generate the visible ray having enhanced brightness so that an LCD device including the surface light source may have an improved image display quality.

This invention has been described with reference to the exemplary embodiments. It is evident, however, that many alternative modifications and variations will be apparent to those having skill in the art in light of the foregoing description. Accordingly, the present invention embraces all such alternative modifications and variations as fall within the spirit and scope of the appended claims.

1. A surface light source comprising:
a body including i) a first substrate having first fluorescent patterns to convert an invisible ray into a visible ray, wherein the first fluorescent patterns are formed in parallel by a first interval, ii) a second substrate facing the first substrate, and iii) at least one space-dividing member interposed between the first and second substrates to form a discharge space, wherein the space-dividing member has a width less than the first interval and the space-dividing member is arranged two adjacent fluorescent patterns; and
a power supply member to generate the invisible ray in the discharge space.

2. The surface light source of the claim 1, wherein the first fluorescent patterns have a substantially bar shape.

3. The surface light source of the claim 2, wherein end portions of the first fluorescent patterns are connected to each other to thereby form a serpentine shape.

4. The surface light source of the claim 1, wherein second intervals between the space dividing member and two adjacent first fluorescent patterns disposed at both sides of the space dividing member are substantially same.

5. The surface light source of the claim 1, wherein the first substrate comprises glass that absorbs an ultraviolet ray passing through the first substrate.

6. The surface light source of the claim 1, wherein the body further comprises a sealing member interposed between the first and second substrates to seal a space between the first and second substrates.

7. The surface light source of the claim 6, wherein at least two space dividing member having a same length are formed in parallel between the first and second substrate, each of the space dividing members has a first end portion and a second end portion corresponding to the first end portion, the first end portions of odd numbered space dividing members and the second end portions of even numbered space dividing members are alternately connected to the sealing member so that the discharge space has a serpentine shape.

8. The surface light source of the claim 6, wherein the space-dividing member has a first end portion and a second end portion that is opposite to the first end portion, the first and second end portions are connected to the sealing member, and a through hole is formed through the space-dividing member.

9. The surface light source of the claim 1, wherein a discharge gas containing mercury (Hg) is filled in the discharge space.

10. The surface light source of claim 1, wherein the power supply member includes a first electrode and a second electrode disposed on the body, for applying a discharge voltage to the body so as to generate a discharge in the discharge space.

11. The surface light source of the claim 1, wherein the second substrate includes a second fluorescent pattern corresponding to the first fluorescent patterns.

12. The surface light source of the claim 11, wherein the first fluorescent pattern has a first thickness thicker than a second thickness of the second fluorescent pattern.

13. The surface light source of the claim 11, wherein the body includes a reflective layer formed between the second substrate and the second fluorescent pattern so as to reflect the visible ray.

14. The surface light source of the claim 1, wherein at least two space-dividing members are formed between the first and second substrates, and at least two first fluorescent patterns are disposed between a pair of the adjacent space-dividing members.

15. The surface light source of the claim 1, wherein the first fluorescent pattern includes a main pattern portion, a first fluorescent sub-pattern portion and a second fluorescent sub-pattern portion, the first fluorescent sub-pattern portion is extended from the main pattern portion so as to make contact with a first space dividing member adjacent to a first end portion of the first fluorescent pattern, the second fluorescent sub-pattern portions extended from the main pattern portion so as to make contact with an second space dividing member adjacent to an second end portion corresponding to the first end portion of the first fluorescent pattern, and a first thickness of the first and second fluorescent sub-pattern portions is thinner than a second thickness of the main pattern portion.

16. A method of manufacturing a surface light source device comprising:
forming at least two first fluorescent patterns on a first substrate to convert an invisible ray into a visible ray, wherein the first fluorescent patterns are formed in parallel by a first interval;
forming a space-dividing member on a second substrate corresponding to the first substrate, wherein the space-dividing member is arranged between two adjacent first fluorescent patterns, and the space-dividing member has a width less than the first interval of the first fluorescent patterns;
assembling the first and second substrates to form a body having a discharge space; and
forming a power supply member at the body to generate the invisible ray in discharge space.

17. The method of claim 16, prior to forming the space-dividing member, further comprising: forming second fluorescent patterns on the second substrate between two adjacent space-dividing members.

18. The method of claim 16, prior to forming the space-dividing member, further comprising: forming a light reflective layer on an entire surface of the second substrate.

19. The method of claim 16, after forming the body, further comprising: providing a discharge gas into the discharge space to generate the visible ray.

20. The method of claim 16, wherein forming the body further comprises forming a sealing member between the first and second substrates to seal the discharge space between the first substrate and the second substrate.

21. The method of claim 16, wherein forming the power supply member comprises forming a first electrode and a second electrode on the body to generate a discharge in the discharge space when a discharge voltage is applied to the first and second electrodes.

22. A liquid crystal display device comprising:
a surface light source including i) a body including a first substrate, a second substrate and a space-dividing member, and a power supply member, wherein the first substrate has first fluorescent patterns to convert an invisible ray into a visible ray, the first fluorescent patterns are formed in parallel by a first interval, the second substrate faces the first substrate, the space-dividing member is interposed between the first and second substrates to form a discharge space, the space dividing member has a width less than the first interval and the space-dividing member is arranged two adjacent fluorescent patterns, and ii) a power supply member that generates the invisible ray in the discharge space; and
a liquid crystal panel converting the visible ray into an image including information using a liquid crystal.

23. The liquid crystal display device of claim 22, further comprising an optical member that is interposed between the liquid crystal display panel and the surface light source so as to make uniform an optical distribution of the visible ray.

24. The liquid crystal display device of claim 23, wherein the optical member includes a diffusion sheet for diffusing the visible ray.
